(19) United States
(12) Patent Application Publication
(10) Pub. No.: US 2008/0098090 A1
(43) Pub. Date: Apr. 24, 2008

(54) Computer implemented system and methods for mapping using web-based content

(75) Inventors: John Begley Geraci, Brooklyn, NY (US); Cory Alfred Forsyth, New York, NY (US); Steven Berlin Johnson, Brooklyn, NY (US)

Correspondence Address: KALOW & SPRINGUT LLP, 488 MADISON AVENUE, 19TH FLOOR, NEW YORK, NY, 10022, US

(73) Assignee: J.S.B.K. Inc., New York, NY (US)

(21) Appl. No.: 11/584,734

(22) Filed: Oct. 20, 2006

(51) Int. Cl. G06F 15/16

(52) U.S. Cl. 709/219

(57) ABSTRACT

Computer implemented systems and methods for mapping using web-based content is provided. In one embodiment, a computer implemented system for mapping over the Internet is provided, comprising: a computer for receiving a map request and a content request from a client computer, the map request including a request for location-based data and the content request including a request for Internet content associated with the location based-data; the computer having a searching component to search a database for content associated with a particular location, a filtering component to filter the content by location and an association component to associate the location-based-data with the filtered content. In another embodiment, the systems and methods provided allow the user to view one or more blogs, wikis, newsfeeds, news stories, podcasts, audio files, movie files and/or photos about a particular location by moving a map display to the particular location.

### BACKGROUND OF THE INVENTION

Many online mapping systems (e.g., Google Maps™, MapQuest®, Yahoo Maps®, etc.) provide an easy way to obtain fast, simple, turn-by-turn directions to many destinations at anytime. Features such as travel guides, sites of interest, airport locators, transportation finders, and other features make online mapping systems widely used.

Typically, online mapping systems display directions in many formats, which can be downloaded, saved, printed, or e-mailed. Some online mapping systems have navigation features that allow the user to view direction by zooming in and/or zooming out in the area selected on the map. Other online mapping systems allow satellite imagery as well.

Although online mapping systems provide an easy and convenient way to obtain directions using the Internet, they do not have any feature that allows a user to view thoughts or ideas and exchange information concerning a particular location. There is a need for online mapping systems and methods that allow a user to view web-based thoughts and ideas shared about a particular location or a group of locations. Online mapping systems and methods that allow a user to view and/or post content information about a particular location (e.g., blogs, wikis, newsfeeds, podcasts, slicker photos, etc.) are needed.

### SUMMARY OF THE INVENTION

In various embodiments, the systems and methods provide a convenient and easy way to view and post Internet content about a particular location. The systems and methods provide a forum for users to view web-based thoughts and ideas shared about a particular location or a group of locations. Thus, the system and methods provided herein go beyond online mapping systems that simply give the user directions to various locations.

In one embodiment, a computer implemented system for mapping over the Internet is provided, comprising: a computer for receiving a map request and a content request from a client computer, the map request including a request for location-based data and the content request including a request for Internet content associated with the location based-data; the computer having a searching component to search for content associated with a particular location that the client requests, a filtering component to filter the content by location and an association component to associate the location-based-data with the filtered content.

In one exemplary embodiment, a computer implemented system for mapping over the Internet is provided, comprising: a client computer for transmitting a map request and a content request over the Internet to a second computer, the map request including a request for location-based data and the content request including a request for Internet content associated with the location based-data that the client requests; the second computer having an association component to associate the location based-data requested with the Internet content and a transmitting component to transmit the associated location based-data and Internet content to the client computer.

In another embodiment, a method for mapping over the Internet is provided, comprising: receiving from a client computer a map request and a content request, which are sent to a host computer by moving a map display to a first position, the map request including a request for location-based data and the content request including a request for Internet content associated with the location based-data; the host computer having an association component to associate the location based-data requested with the Internet content and transmitting the associated location based-data and Internet content to the client computer.

In another exemplary embodiment, a computer readable storage medium is provided for storing instructions that, when executed by a computer, cause the computer to: i) receive a map request and a content request from a client computer, the map request including a request for location-based data and the content request including a request for Internet content associated with the location based-data; ii) search a database for content associated with a particular location; iii) filter the content by location; iv) associate the location-based-data with the filtered content; and v) transmit the associated location based-data and Internet content to the client computer for display.

In various embodiments, a computer implemented system for mapping over the Internet is provided, comprising: displaying a map display on a client computer, moving the map displayed on the client computer to a first position to transmit a content request over the Internet to a second computer, the content request including a request for Internet content associated with the first position on the map; the second computer having an association component to associate the first position with the Internet content associated with the first position on the map and a transmitting component to transmit the content associated with the first position to the client computer.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE FIGURES

FIG. 1 illustrates system architecture of one embodiment for mapping over the Internet.

FIG. 2 illustrates system architecture for mapping over the Internet utilizing servers coupled to a mapping database and a content database.

FIG. 3 is a flow chart illustrating an embodiments of steps performed by the system when a request is entered.

FIG. 4 is a flow chart illustrating one embodiment of the steps the system performs to display location-based data with content.

FIG. 5 illustrates one embodiment of a welcome page of the computer-implemented mapping system, where the client enters the system.

FIG. 6 illustrates a typical web page displaying the search results, in this example, blogs that are retrieved in a particular area about a particular topic.

FIG. 7 illustrates an information path where the system utilizes tags and associates these tags with content.

FIGS. 8-10 illustrates typical web pages displaying search results, in this example, blogs showing a particular topic associated with a particular location.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION OF THE INVENTION

Reference will now be made in detail to certain embodiments of the invention, examples of which are illustrated in the accompanying drawings. While the invention will be described in conjunction with the illustrated embodiments, it will be understood that they are not intended to limit the invention to those embodiments. On the contrary, the invention is intended to cover all alternatives, modifications, and equivalents, which may be included within the invention as defined by the appended claims.

It is noted that, as used in this specification and the appended claims, the singular forms “a,” “an,” and “the,” also include plural referents unless expressly and unequivocally limited to one referent. Thus, for example, reference to “a location” includes one, two, three or more locations.

The headings below are not meant to limit the disclosure in any way; embodiments under any one heading may be used in conjunction with embodiments under any other heading.

In various embodiments, the systems and methods provide a convenient and easy way to view and post Internet content about a particular location. The systems and methods provide a forum for users to view web-based thoughts and ideas shared about a particular location or a group of locations. For example, if a client is interested about blogs on the web posted in the client's area or about a particular location, the client would access the system and enter the particular address; the system would display a map interface. The user then can move the map to various locations and the system would provide the client with a list or index of blogs in that area. The client can then see what was said about a particular location or, in various embodiments, post some thoughts about the location. Thus, the system and methods provided herein go beyond online mapping systems that simply give the user directions to various locations. In various embodiments, the map display functions as a type of joy stick, which controls the content that will be displayed. Thus, moving the map up, down, right, left, zooming in or out will change the content displayed.

In various embodiments, a computer implemented system for mapping over the Internet is provided, comprising: a computer for receiving a map request and a content request from a client computer, the map request including a request for location-based data and the content request including a request for Internet content associated with the location based-data; the computer having a searching component to search the database for content associated with a particular location, a filtering component to filter the content by location and an association component to associate the location-based-data with the filtered content.

Map Database

In various embodiments, the system and methods provide location based-data and associate it with content. Location-based data includes, but is not limited to, private, public, or historic, landmarks, cities, states, neighborhoods, countries, postal addresses, zip codes, longitude/latitude coordinates, attractions, objects or locations, such as buildings, monuments, artworks, tracts of land or other items that may be of interest to any person, for either tourist, commercial, residential, academic, historic or religious reasons. Thus, a hotel, a restaurant, a store, a ski resort, an airport, an apartment, a house, a housing development, a city, a country, position of a vehicle, a church, a bank, a school, a hospital may qualify alone or in combination as location based-data.

The location-based data may be stored in a map database. The map database may be one or more of the known storage devices or systems (e.g., Random Access Memory (RAM), Read Only Memory (ROM), hard disk drive (HDD), floppy drive, zip drive, compact disk-ROM, DVD, bubble memory, redundant array of independent disks (RAID), network accessible storage (NAS) systems, storage area network (SAN) systems, etc.). The database may also comprise one or more memory devices embedded within a CPU, or shared with one or more of the other components, and may be deployed locally or remotely relative to one or more components interacting with the memory or one or more processors, routines, and/or modules.

The mapping system and methods comprises a processor, which typically executes one or more executable instructions or programs that instructs the system to search, retrieve, filter, associate, save, send, display location-based data and/or content information. It will be understood that the client computer, host computer, processor, map database, content database, user interface, can include one or more processors and databases to expedite communication among the various interfaces of the mapping systems.

Although the databases, processors, servers, may be shown or described herein as physically separated components (e.g., map database, content database, etc.), it should be readily apparent that the databases, processors, servers, as described herein may be merely logical constructs or routines that are implemented as physical components combined or further separated into a variety of different components, sharing different resources (including processing units, memory, clock devices, software routines, logic commands, etc.) as required for the particular implementation of the embodiments disclosed. Indeed, even a single general-purpose computer (or other processor-controlled device) executing a program stored on an article of manufacture (e.g., recording medium or other memory units) to produce the functionality referred to herein may be utilized to implement the illustrated embodiments.

In one embodiment, the method and system allows the user to specifically input special queries on the data (e.g., zip code), and a map will display on the user's browser. The user can move the map using directional icons, which controls the content that will be displayed. Thus, moving the map up, down, right, left, zooming in or out will change the content displayed. In various embodiments, the user can select content related to a particular topic, e.g. recent posts: schools, kids, crime, restaurants, bars, politics, real estate, open houses, jobs, sports, gossip, rants, arts, transit, local issues, community, shopping, music, romance, etc. When the map is moved relevant content based on the location will be displayed. For example, if the user selects restaurants in the zip code 11215, a map will be displayed and, for example, blogs related to restaurants in that area will be displayed. The user can then review these blogs and decide if he/she wants to visit the restaurant.

In another embodiment, the method and system allows the user to specifically input special queries on the data, and superimpose the results on a map graphically. For example, the user may input a query for blogs within a particular postal address; the user is also able to visually locate the address the user wants displayed. The user will also able to view blog information (e.g., blog index) about the particular location. The blogs may be integrated with icons, without having to go to another web page to see those details. In various embodiments, if a map is displayed, various types of content information may be embedded in the map, and the user can selectively display the desired types of content as icons on the map.

In one embodiment, the mapping system permits the user to specify location queries using location-based data e.g., non-postal addresses, such as for example, landmark name, business name, or personal address book, for use as a local search input parameter. The location based data will be associated with particular content regarding the location and the results will be displayed, for example, as a map using the location as a center point, or the map may be a map of a corridor of a user specified width connecting two landmarks. For example, a query might include blogs within 1 mile of Central Park in New York City.

In various embodiments, the system allows the user to search for content by neighborhood name either by a Boolean or free form search.

In one embodiment, the map has the location of interest as its center point (e.g., latitude/longitude, postal address or any other location-based data). In this case, the system allows the user, using a Web browser, to zoom in or out of the particular areas selected and content data is displayed on the map. For any given map defined by its center point and zoom level, only content that fall within the geographical area of the map are displayed by the system. For example, the system will determine if particular content is located within the current radius of the center of the map. In some embodiments, the current radius is a function of the current zoom level. In other embodiments, the current radius may be either an optional filter criterion or a mandatory input parameter entered by the user. If the content is located outside of the current radius, then the content is not added to the map, if the content is located within the current radius, then the content will be displayed.

In various embodiments, the system utilizes online mapping systems for the location-based data, such as for example Google Maps™, MapQuest®, Yahoo Maps, Microsoft® MapPoint or other mapping software that is available.

In various embodiments, the system takes content (e.g., currently events, posts and articles, etc.) and associates the content with location (e.g., via zip code, longitude/latitude, street address, etc.). For example, the system associates content with zip code, and since the system has longitude/latitude data for every zip code all the data is implicitly associated with longitude/latitude data as well. In various embodiments, some data is associated with a particular longitude/latitude or street address as well.

Content

The systems and methods provided utilize Internet content relating to a particular location. As used herein, content is material of interest relating to a particular location. Often, the content is put on the Web and changed frequently in order to encourage visits to the content page. Internet content includes one or more blogs, wikis, newsfeeds, news stories, podcasts, audio files, movie files and/or photos. Audio files can be compressed audio (e.g., MPEG-1, MPEG-2, MP3) or video data, photo files can be of any suitable formats. Content may be viewed and/or posted by one or more of the same or different users.

Blogs include updated Web logs that often have fresh Web information relating to a specific location. For instance, in many cases blogs are used as a daily diary regarding a particular location of the author or a commentary reflecting the viewpoint of the author about a location. In various embodiments, the blogs include link-driven Web sites containing the personal commentaries of one or more authors about a particular location. Blogs allow easy collaboration about a particular location not only by the original blog poster, but also by others who visit the blog. Typically, blogs are viewed utilizing a web browser, where the user can view the log for that particular location. In various embodiments, a blog post may be associated with, for example, a particular café, which is correlated with a certain neighborhood and longitude/latitude.

In one exemplary embodiment, the system utilizes Really Simple Syndication (RSS), which is an XML-based format that allows the syndication of content ranging from lists of hyperlinks to blog postings. To enable the syndication of content, the Web site can publish a RSS feed, or channel. Once a feed becomes available, content browsers can regularly retrieve the RSS feed to receive the most recently published content regarding the location. In various embodiments, the system will utilize RSS to syndicate the aggregated content material. Other alternatives to RSS may be utilized including, for example, ATOM or the like.

Wikis include an online collaborative environment in which the user can write and change the web page about a particular location. Newsfeeds include a web file, which allows a user to receive updated information, announcements, and news stories relating to the location. In various embodiments, the newsfeed comprises RSS or ATOM files. Podcasts are types of newsfeeds, with links to audio or video files about a particular location.

In various embodiments, the content may include a directory page or index that lists newsfeeds, blogs, wikis, and/or podcasts about a particular location. The directory may also include a link to the content, which the user can access by clicking on the link. In various embodiments, the content or metadata associated with a particular content is tagged with a code embedded in an HTML or other markup language to tell Web browsers how to display a portion of the text or an image. For example, the tag may incorporate a message, which allows a user to view information about a particular location (e.g., party next week coming up at a neighborhood's landmark).

Tags allow users of the site to apply metadata to a particular piece of content, adding contextual information about the nature of that content. This metadata is then viewable by other users giving them a better idea of the nature of that content before viewing it. It also allows for better organization of the content on a macro level, as the site then categorizes all content according to how it is tagged by the users. In various embodiments, there is a core set of predefined tags that can be applied easily by users in order to apply basic metadata to each piece of content. The core tags are What, Where and When—any piece of content appearing can be tagged with any of these tags, with additional information attached to the tag to indicate details about a piece of content as far as what it is, where it is and when it is occurring (if it is an event). In other embodiments, users can tag any piece of content with any word they want in order to give other users more contextual information about that content (e.g. a blog entry about a break-in attempt might be tagged “crime” by a user, so that other users can more easily reference that information). Additionally, the system adopts any tags that the content's author may have applied to the content on the original host site.

The tag may also identify a content web page and/or content that expedites filtering and association of the content with a particular location. In various embodiments, the content may be presented using AJAX or other interactive web applications that make it easier for a user to update content. For example, in various embodiments, AJAX can be utilized for searching and navigating content.

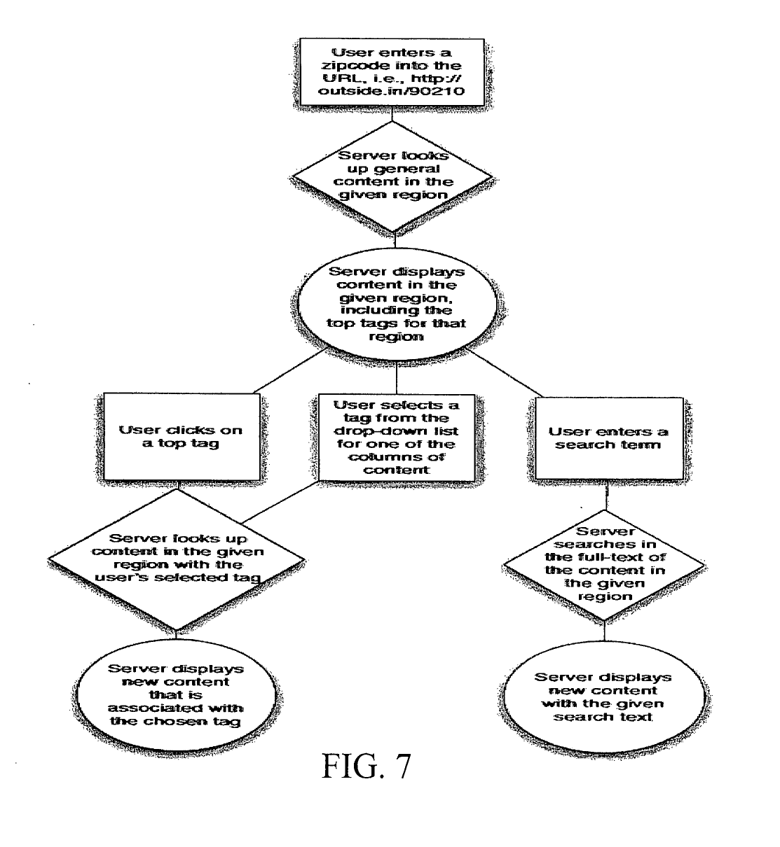

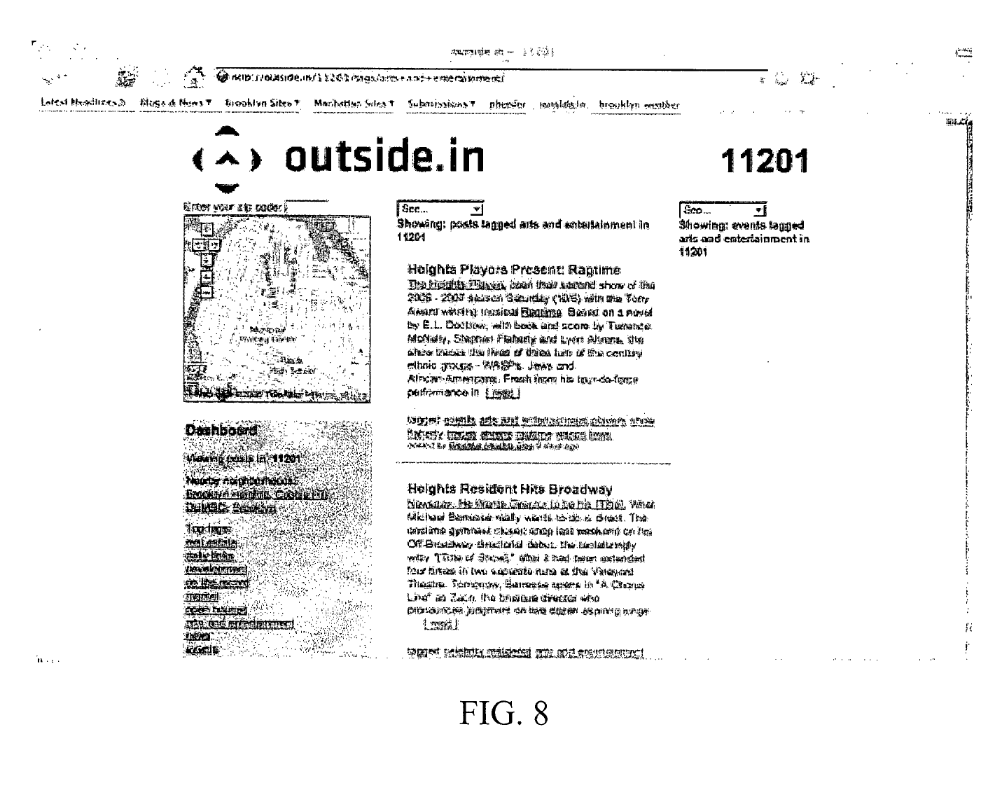

FIG. 7 illustrates a flow path for one embodiment where tags are utilized and associated with particular content that aids searching and display. In this embodiment, a user enters their zip code, the server looks up general content in a given region. The results are displayed and content in the given region are shown as well as the top tags in that region. The user can click on a top tag (or selects from a drop down menu) and the server looks up content in the given region with the user's selected tag and the server will display the new content associated with that tag. In other embodiments, the user can enter a new search term and the server searches in the full text of the content for that given region and the server displays new content with the given search text. FIG. 8 illustrates a typical web page displaying the search results using tags, in this example, blogs that are retrieved in the entertainment area associated with the 11201 zip code.

Search Component

In various embodiments, the system and methods allow a user to select certain search criteria, (e.g., blogs about Silicone Valley, Calif.) so that only content meeting the particular criteria are displayed. The search routine will search for content meeting the criteria and the system will filter only those that meet the search criteria, where it can be displayed, stored, tagged and/or transmitted. In various embodiments, the user can change the filtering and/or search criteria and request that the map be updated to reflect the changes.

In some embodiments, additional filtering criteria may include distance from the center of the map; distance from another selected location, or price range. However, filtering criteria based on attributes associated with any particular location may be used. Other filtering criteria may be tailored to each application and content type. For example, the user can select content related to a particular topic, e.g. recent posts, schools, kids, crime, restaurants, bars, politics, real estate, open houses, jobs, sports, gossip, rants, arts, transit, local issues, community, shopping, music, romance, etc. to filter out content that does not meet the request. For example, the user may be provided the ability to display blogs in a particular school district in which the average scholastic aptitude test score exceeds a threshold level.

In various embodiments, the content can also be tagged to allow the system and/or user to search the content that meets the search criteria. The tag can allow the user to enter information concerning: what is the location of interest, where the location of interest is, and/or when a particular event relating to the location will occur.

Typically, the search module includes a searching component with a search engine provided (alone or in conjunction with other hardware or software) to control the search and retrieval of content and/or location-based data (e.g., metadata) that is available on the Internet or stored on a database using search criteria or queries formulated by the system and/or user. A search engine may provide text-based, graphics-based, code-based, or other search/query mechanisms to produce search results to be viewed, accessed, edited, transmitted or otherwise output to be saved in the database or viewed by a user. Transmit includes, but is not limited to, delivery by electronic means of communication one or more messages or to send one or more messages from one place or person to another place or person utilizing a device.

In one embodiment, for example, the search module performs searches based on input data such as: postal address, zip code, longitude/latitude, keywords; text or graphics; Boolean logic characters, or other search criteria (e.g., date restrictions, etc.).

In various embodiments, the search engine is programmed to permit editing or refinement of the search criteria or query to perform additional searches on different data sets or the data set produced from the initial search results. Results of the search or query are collected for storage, display, or other output to the user. The system may interact with one or more computers, servers, networks and/or other search engines. Each search engine is used to locate data items that match the user's filtering criteria and, in various embodiments, is in the proximity of the map center point. The retrieved and/or filtered data can be stored in the content database or map database and updated by the search engine. Commercial products such as Oracle DBMS, or free ones such as MySQL DBMS could also be used for the search engine. In one embodiment, MYSQL is utilized by the system, which is an open source relational database management system (RDBMS) that uses Structured Query Language (SQL), the most popular language for adding, accessing, and processing data in a database.

The search engines can be hosted locally or on remote servers, or the entire system can be on one device. The remote servers can even include third party servers. The communication between the mapping application and the search engine can occur utilizing standard Internet protocols (e.g., hypertext transport protocol, or HTTP) and the results from the mapping application are formatted in a parsable format (e.g., Extensible Markup Language, or XML). This design allows the system to easily incorporate items from disparate sources. Any other appropriate communication protocol may be used.

In accordance with an embodiment, one or more user interfaces can be provided as part of (or in conjunction with) the illustrated systems to permit users to interact with the systems. User interfaces may include one or more display devices (e.g., CRT, LCD, or other known displays) or other output devices (e.g., printer, etc.), and one or more input devices (e.g., keyboard, mouse, stylus, touch screen interface, or other known input mechanisms) for facilitating interaction of a user with the system. The user interface may be wired or wireless (e.g., wireless personal area networks e.g., Bluetooth, wi-fi, cellular, etc.).

In various embodiments, the user interface may be implemented as a graphical user interface (GUI) containing a display or the like, or may be a link to other user input/output devices known in the art. Individual devices, or a plurality of devices (e.g., network/stand-alone computers, PDAs, WebTV (or other Internet-only) terminals, set-top boxes, cellular/PCS phones, screenphones, pagers, kiosks, blackberries, peer/non-peer systems or technologies or other known (wired or wireless or remote) communication devices, etc.) may similarly be used to execute one or more computer programs (e.g., universal Internet browser programs, dedicated interface programs, etc.) to allow a user to interface with the systems in the manner described.

It should be readily apparent that a “user” of the various aspects of the inventive systems or methods disclosed herein may be one or more individuals (e.g., customers, clients, etc.), entities, including companies, businesses, without departing from the scope of the invention.

In various embodiments, the user can be assigned user identifiers, PIN, and passwords by systems manager or administrator. These reduce the chance of access by unauthorized users. The system administrator or manager may be responsible for access and security of the system (e.g., hackers, viruses, worms, spy ware, etc.).

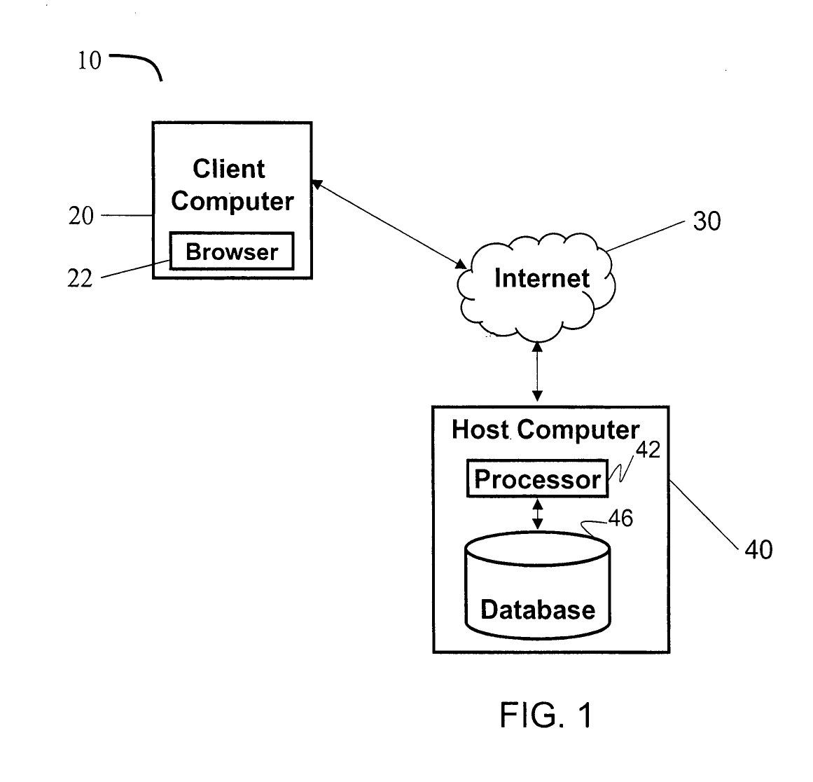

FIG. 1 illustrates system architecture in accordance with one embodiment, where the mapping system 10 comprises a client computer 20 having a browser 22 that allows the user to view location-based data and content. The client computer is capable of accessing the Internet 30 and host computer 40. Database 46 stores some or all information about location-based data and/or content about a particular location. Processor 42 is coupled to database 46, the processor receives and sends content and/or location-based information stored on the database or will search the database 30, in response to a query. The processor may also contain mapping and/or content software that will also execute routines to associate content data with a particular location, collect data that meets the search query and further filter the data as requested. The processor will also execute commands of the mapping user interface, and allow the user to interact with the display and transmit the user's request to the mapping application that can be displayed on the browser. In various embodiments, the processor provides mapping applications for running the mapping software to generate and transmit maps to the server that receives the query from the user. The processor, in this embodiment, is used to coordinate the functions of the map database, content database, search engine, and/or client computer.

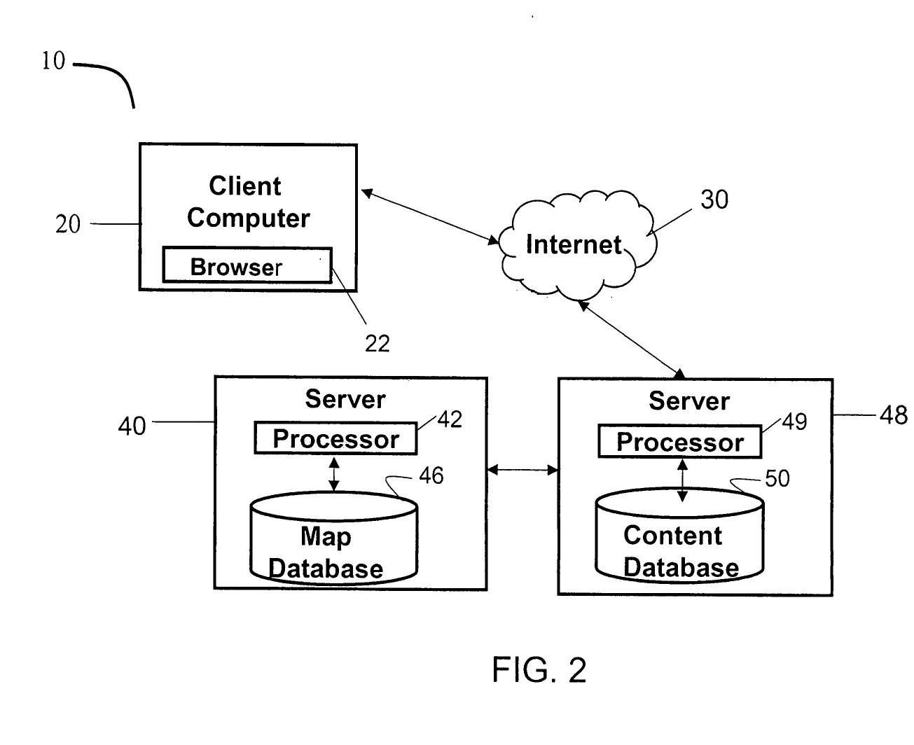

FIG. 2 illustrates system architecture in accordance with one embodiment, where the mapping system 10 comprises a client computer 20 having a browser 22 that allows the user to at least view location-based data and content over the Internet 30. In this embodiment, two separate servers (40 map server and 48 content server) are shown that allow access to the Internet. Map database 46 stores location-based data. Processor 42 and server 40 allow data to be transmitted to and from the Internet, and control access to the database 46 as well as searching, associating, and/or filtering data. Content database 50, stores content data about a particular location (e.g., blogs, wikis, etc.). Processor 42 and/or 49 controls access to the database, searching, associating, filtering and/or transmitting. Servers 40 and 48 manage the interaction between the web browser 22 and the mapping and/or content applications. In various embodiments, the request comes into the content server and the server determines the size of the area the client is asking for and what the geographic center of the area is, then requests a map with those parameters from the map database, which returns the information to the content server for sending to the client's browser.

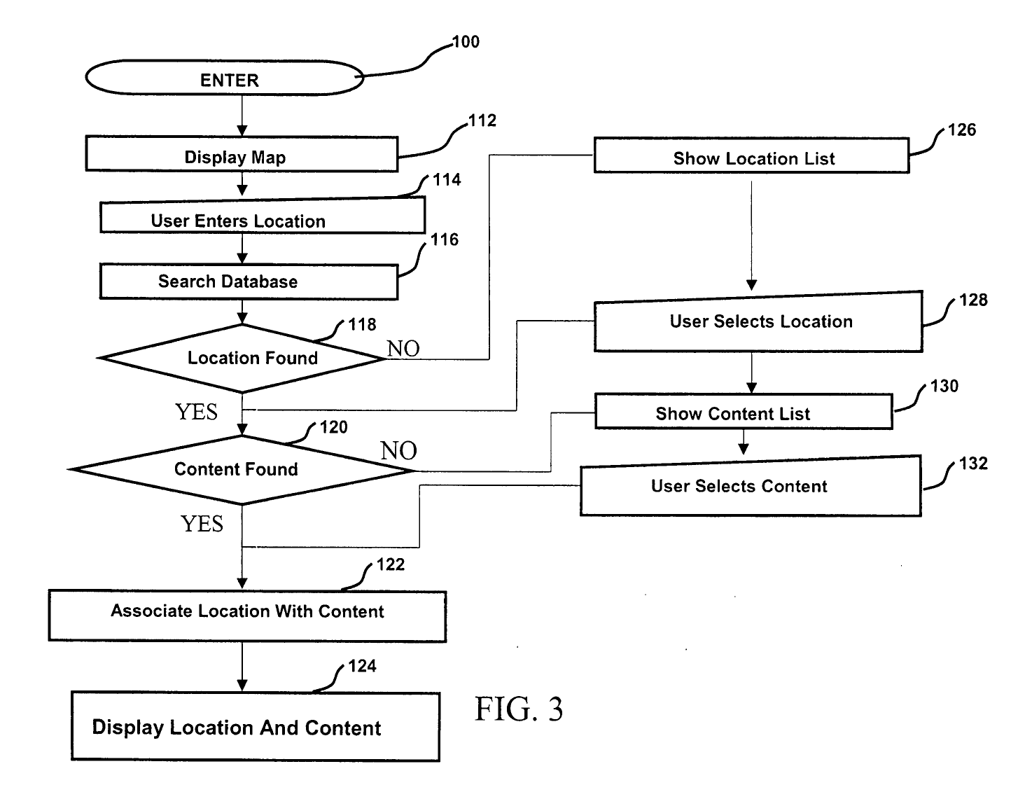

FIG. 3 is a flow chart of one embodiment showing steps performed for each request coming from the web browser 22, specifying a map center point, zoom level, search criteria and/or filtering criteria. The user enters the website 100, a map is displayed or area for data entry about a location 112, the user enters a particular location 114. The database is searched 116 for the location. If the location is found the user will select the type of content that they are looking for 120. If the location is not found, the system will direct the user to a location list or index 126, which the user can select a particular location 128. The user will then proceed to content information and see if content will be found 120. If content is not found, the user will be shown a list of content 130, which the user can select. The system will associate the location with the particular content 122 the user is interested in (e.g., blogs at 1313 Mockingbird Lane). The results will be displayed 124 by location and/or content on the web browser or other user interface.

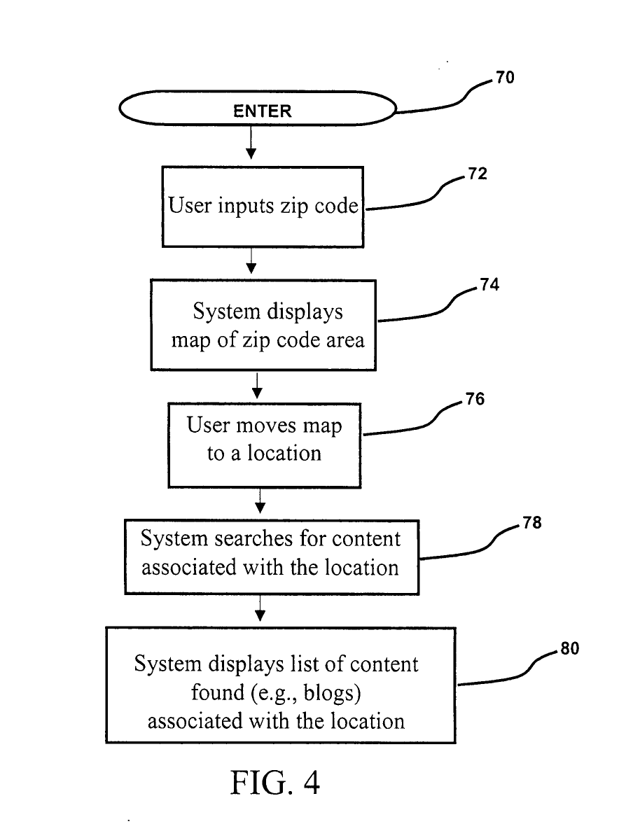

FIG. 4 is a flow chart illustrating one embodiment of the information flow for the system. The user enters the system 70 by entering user name and password and then the user inputs a zip code. The system displays a map 74 of the zip code area. To view various content, the user moves the map location 76 to the desired location and the system searches the database (e.g., content database) for content associated with that particular location 78. The content associated with the location is displayed 80. In various embodiments, the user can select content by topic, so that when the map is moved, blogs regarding that topic (e.g. recent posts, schools, kids, crime, restaurants, bars, politics, real estate, open houses, jobs, sports, gossip, rants, arts, transit, local issues, community, shopping, music, romance, etc.) are displayed. Thus, the system is capable of filtering out content that does not relate to the particular topic.

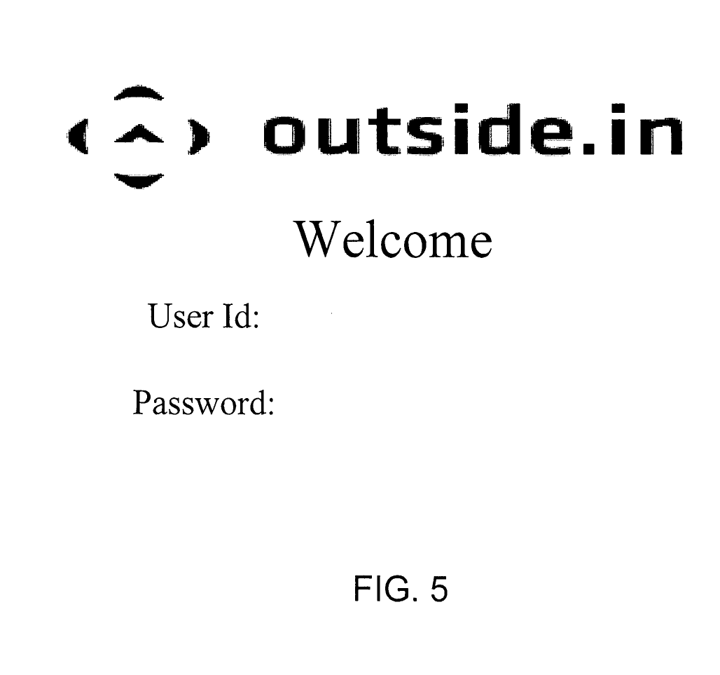

FIG. 5 illustrates one embodiment of a welcome page of the computer-implemented mapping system, where the client enters the system. The user is given options to enter user ID and passwords.

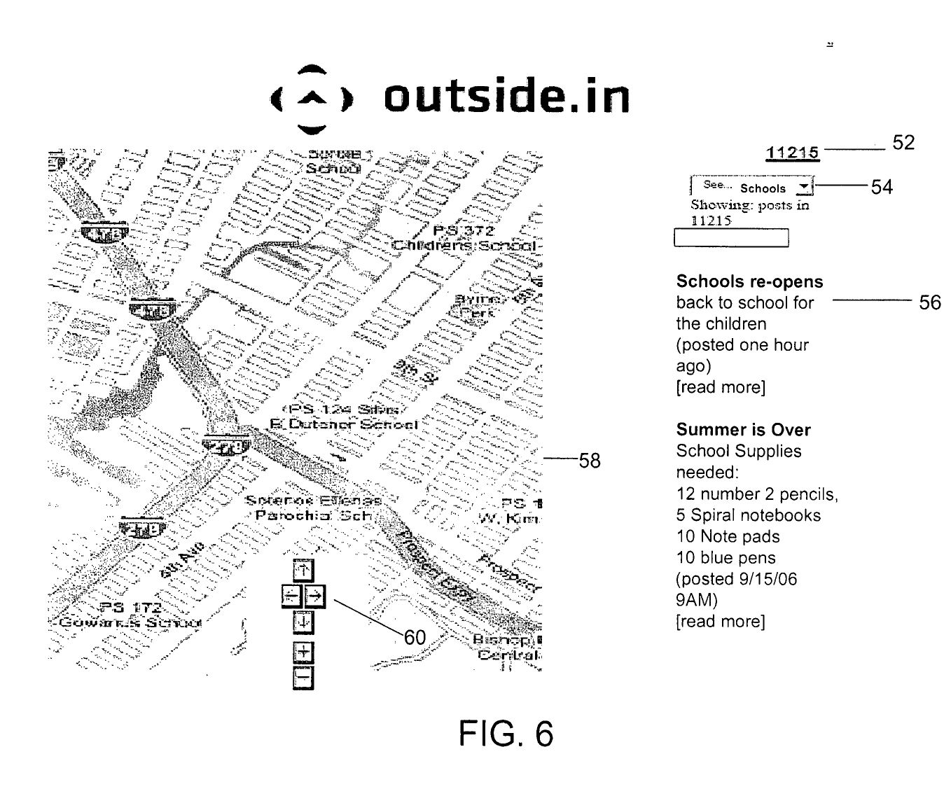

FIG. 6 illustrates one embodiment of a typical web page to perform a search for blogs in a particular area. The user inputs a zip code 52 that he/she is interested in and a map display 58 for that zip code will appear on the user's browser. Blogs associated with that area will appear 56. The user has the option of filtering blogs by topic in that location (e.g. schools 54) and blogs relating to the schools in that area will appear as an index or text. The user can then move the map in different positions (e.g., first, second, third, fourth, etc.) using directional bars 60 to move up, down, right, left, zoom and/or zoom out of a particular location. The map movement controls the content of the blogs that appear. In this example, blogs associated with schools in zip code 11215 will appear, and a search query that a client enters to retrieve, in this example, blogs about a particular area.

The mapping system and methods provided may comprise a reports generator (alone or in conjunction with the processor, database, server and/or user interface) in providing reports regarding the location-based data and/or content. Reports generator, for example, may be programmed to allow users to create and store templates or other forms to be populated during report generation. Reports may then be generated manually or automatically from selected information (e.g., location, updated blogs, etc.). These reports may be printed or sent to the user (e.g., via e-mail, fax, regular mail, courier, etc.) in any desired format (e.g., printed, stored on electronic media such as CD-ROM, etc.). Alternatively, the report can be viewed on the user, interface. In various embodiments, location-based data and/or content information may be downloaded in one or more textual/graphical formats (e.g., RTF, PDF, TIFF, etc.).

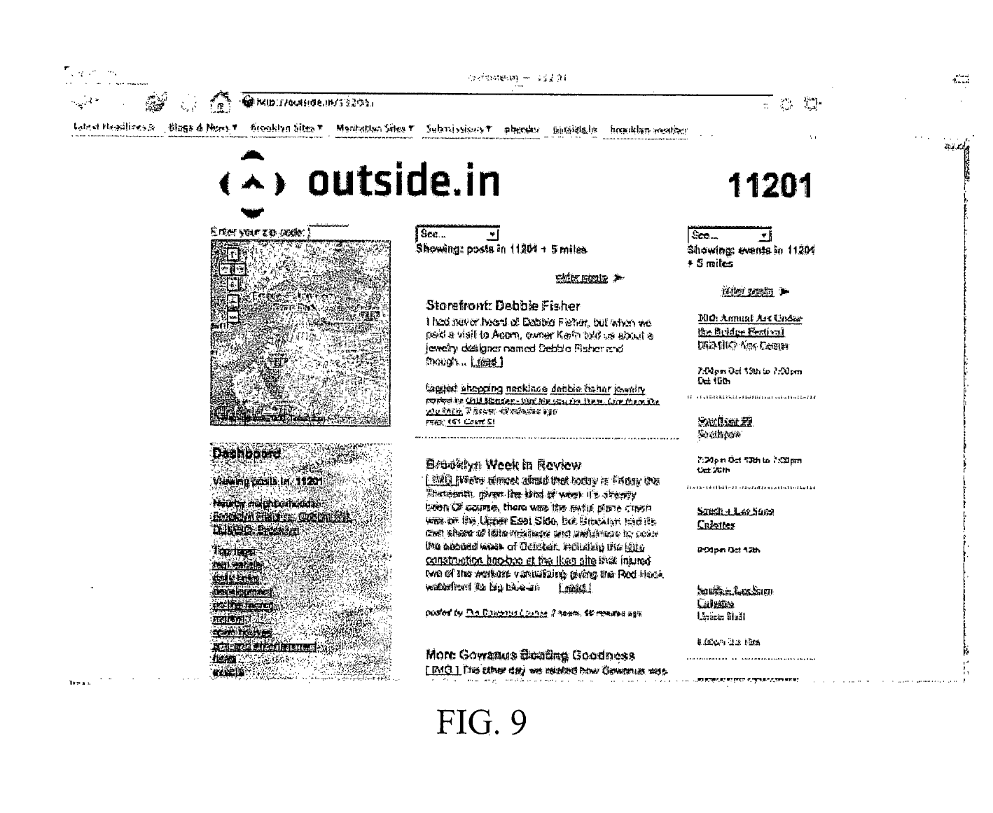

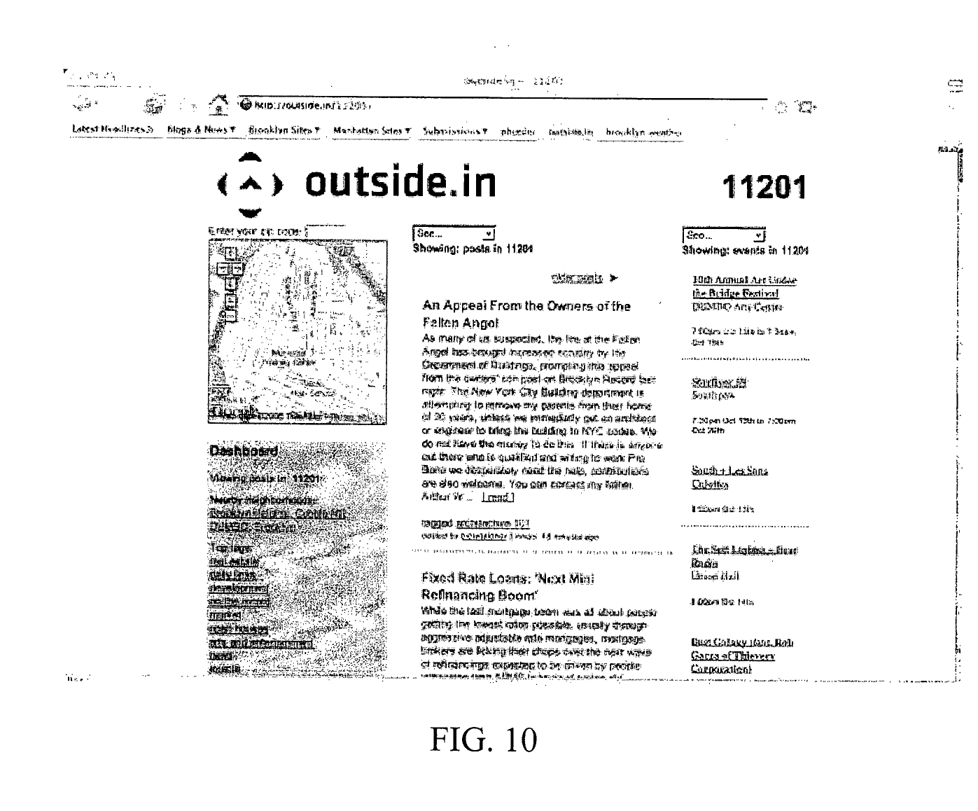

FIGS. 9 and 10 illustrate typical web pages displaying the search results, in this example, blogs that are retrieved showing events and posts within a 5-mile radius associated with the 11201 zip code or blogs in the 11201 zip code area without the radius restriction selected.

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

What is claimed is:

1. A computer implemented system for mapping over the Internet, comprising: a computer for receiving a map request and a content request from a client computer, the map request including a request for location-based data and the content request including a request for Internet content associated with the location based-data; the computer having a searching component to search for content associated with a particular location that the client requests, a filtering component to filter the content by location and an association component to associate the location-based-data with the filtered content.

2. A computer implemented system for mapping according to claim 1, wherein the map request and the content request are initiated by the client moving a map displayed on the client computer in a first position to display content associated with the particular location.

3. A computer implemented system for mapping according to claim 1, wherein the Internet content comprises one or more blogs, wikis, newsfeeds, news stories, podcasts, audio files, movie files and/or photos.

4. A computer implemented system for mapping according to claim 1, wherein the location-based data comprises at least one zip code, postal address, longitude-latitude point on a map, interactive map, satellite image, aerial photograph, or rasterized vector map.

5. A computer implemented system for mapping according to claim 1, further comprising transmitting the associated location-based data to the client computer.

6. A computer implemented system for mapping according to claim 5, wherein the transmitted data is displayed on the client computer via a web browser as a map with the Internet content displayed as pop-up text.

7. A computer implemented system for mapping according to claim 5, wherein the transmitted data is displayed on the client computer via a web browser as a map configured to allow the client to slide the map and zoom in from a large geographical area on the map to a smaller geographical area on the map or zoom out from a small geographical area on the map to a larger geographical area on the map.

8. A computer implemented system for mapping according to claim 5, wherein the transmitted data is displayed on the client computer via a web browser as a map with the Internet content displayed as an index of links to blogs, wikis, newsfeeds, podcasts, audio files, movie files and/or photos for the particular location.

9. A computer implemented system for mapping according to claim 1, wherein the location-based data is stored in a map database and the Internet content about a particular location is stored in a content database.

10. A computer implemented system for mapping according to claim 1, wherein the association component comprises a linking routine to link the location-based data with particular Internet content.

11. A computer implemented system for mapping according to claim 10, wherein the location-based data and/or the Internet content is identified with a tag to filter to the data or content.

12. A computer implemented system for mapping over the Internet, comprising: a client computer for transmitting a map request and a content request over the Internet to a second computer, the map request including a request for location-based data and the content request including a request for Internet content associated with the location based-data that the client requests; the second computer having an association component to associate the location based-data requested with the Internet content and a transmitting component to transmit the associated location based-data and Internet content to the client computer.

13. A computer implemented system for mapping according to claim 12, wherein the map request and the content request are initiated by the client moving a map displayed on the client computer in a first position to display content associated with the particular location.

14. A computer implemented system for mapping according to claim 12, wherein the Internet content comprises one or more blogs, wikis, newsfeeds, news stories, podcasts, audio files, movie files and/or photos.

15. A computer implemented system for mapping according to claim 12, wherein the location-based data comprises at least one zip code, postal address, longitude-latitude point on a map, interactive map, satellite image, aerial photograph, or rasterized vector map.

16. A computer implemented system for mapping according to claim 12, wherein the transmitted data is displayed on the client computer via a web browser as a map overlaid with Internet content, the map display is configured to allow the client to move the map and zoom in from a large geographical area on the map to a smaller geographical area on the map or zoom out from a small geographical area on the map to a larger geographical area on the map.

17. A method for mapping over the Internet, comprising: receiving from a client computer a map request and a content request, which are sent to a host computer by moving a map display to a first position, the map request including a request for location-based data and the content request including a request for Internet content associated with the location based-data; the host computer having an association component to associate the location based-data requested with the Internet content and transmitting the associated location based-data and Internet content to the client computer.

18. A method for mapping over the Internet according to claim 17, wherein the Internet content comprises one or more blogs, wikis, newsfeeds, news stories, podcasts, audio files, movie files and/or photos.

19. A method for mapping over the Internet according to claim 17, wherein the location-based data comprises at least one zip code, postal address, longitude-latitude point on a map, interactive map, satellite image, aerial photograph, or rasterized vector map.

20. A method for mapping over the Internet according to claim 17, wherein the transmitted data is displayed on the client computer via a web browser as a map configured to allow the client to slide the map and/or zoom in from a large geographical area on the map to a smaller geographical area on the map or zoom out from a small geographical area on the map to a larger geographical area on the map to display the content.

21. A method for mapping over the Internet according to claim 20, wherein the host computer is coupled to a map server and a content server, wherein the map server transmits the location-based data representing the map to the client computer, and the content server transmits the Internet content associated with the location-based data to the client computer, and the client computer receives the data representing the map separately from the Internet content.

22. A computer readable storage medium storing instructions that, when executed by a computer, cause the computer to: i) receive a map request and a content request from a client computer, the map request including a request for location-based data and the content request including a request for Internet content associated with the location based-data; ii) search a database for content associated with a particular location; iii) filter the content by location; iv) associate the location-based-data with the filtered content; and v) transmit the associated location based-data and Internet content to the client computer for display.

23. A computer implemented system for mapping over the Internet, comprising: displaying a map display on a client computer, moving the map displayed on the client computer to a first position to transmit a content request over the Internet to a second computer, the content request including a request for Internet content associated with the first position on the map; the second computer having an association component to associate the first position with the Internet content associated with the first position on the map and a transmitting component to transmit the content associated with the first position to the client computer.
